(19) United States
(12) Patent Application Publication
(10) Pub. No.: US 2024/0393201 A1
(43) Pub. Date: Nov. 28, 2024

(54) Device and Method for Detecting Imbalance of a Wheel of a Vehicle, and a Vehicle that Comprises the Device

(71) Applicant: Robert Bosch GmbH, Stuttgart (DE)

(72) Inventors: Florian Mueller, Schorndorf (DE); Thomas Benkendoerfer, Aalen (DE)

(21) Appl. No.: 18/617,861

(22) Filed: Mar. 27, 2024

(30) Foreign Application Priority Data
May 24, 2023 (DE) 10 2023 204 830.2

(51) Int. Cl. G01M 1/28

(52) U.S. Cl. CPC G01M 1/28

(57) ABSTRACT

A method for imbalance detection of a wheel of a vehicle by providing a motor torque of a motor of a steering system of the vehicle, providing a position of a rotor of the motor, and detecting the imbalance of a wheel as a function of the motor torque and the rotor position. A vehicle. The method is performed by a vehicle and/or a device.

This application claims priority under 35 U.S.C. § 119 to application no. DE 10 2023 204 830.2, filed on May 24, 2023 in Germany, the disclosure of which is incorporated herein by reference in its entirety.

The present disclosure relates to a device and a method for detecting imbalance of a wheel of a vehicle and a vehicle that comprises the device.

### BACKGROUND

The vibrations caused by wheel imbalances have so far only been perceived subconsciously or consciously by the driver. This means that, with the exception of detected signs of wear that can be attributed to unbalanced wheels, the driver is the only person who detects unbalanced wheels.

### SUMMARY

Imbalances are detected with the aid of the method, the device and the vehicle according to the disclosure.

The purpose of the method for detecting imbalance of a wheel of a vehicle is to provide a motor torque of a motor of a steering system of the vehicle, wherein the motor has a rotor, wherein a rotor position of the rotor is provided, wherein an imbalance of the wheel is detected depending on the motor torque and the rotor position.

To detect the wheel having the imbalance, the method may provide that an amplitude of a wheel rotational speed of the wheel is determined, wherein an amplitude of the imbalance is determined, wherein the imbalance of the wheel is detected if the amplitude of the wheel rotational speed correlates with the amplitude of the imbalance, wherein otherwise no imbalance of the wheel is detected.

The amplitude of the rotational speed of the wheel is preferably determined for at least two wheels of the vehicle, wherein the imbalance of the wheel whose amplitude of the rotational speed of the wheel correlates better with the amplitude of the imbalance is detected.

To better determine fluctuations, for example, the rotational speed of the wheel is preferably filtered as a function of a rotation frequency of the wheel, wherein the amplitude of the rotational speed of the wheel is determined as a function of the rotational speed of the wheel filtered with the rotation frequency of the wheel.

In one example, a spectrum of the motor torque and/or the rotor position is determined with a spectral analysis, in particular by means of Fast Fourier Transformation, or with an artificial intelligence trained for this purpose, wherein the imbalance is detected if the spectrum deviates from a target spectrum.

To output a warning to a driver, for example, it is detected whether the amplitude of the wheel imbalance exceeds a threshold or not, wherein if the amplitude of the imbalance exceeds the threshold, a message is displayed to the driver of the vehicle indicating the imbalance, and otherwise the displaying is not triggered.

To output information about the wheel to be serviced, the wheel on which the imbalance is detected is determined, wherein the displaying of the message identifies the wheel on which the imbalance is detected.

For analysis or evaluation, for example, it is detected whether the amplitude of the imbalance of the wheel exceeds a threshold or not, wherein either if the amplitude of the imbalance exceeds the threshold, data is sent or stored which characterizes the amplitude of the imbalance or a progression of the amplitude of the imbalance, or data is sent which triggers a service appointment, and otherwise the data is not sent.

The device for detecting imbalance is designed to identify a motor torque of a motor of a steering system of the vehicle, wherein the motor has a rotor, wherein the device is designed to identify a rotor position of the rotor and to detect an imbalance of the wheel depending on the motor torque and the rotor position.

The device can be designed to identify an amplitude of a rotational speed of the wheel, to determine an amplitude of the imbalance, and to detect the imbalance of the wheel if the amplitude of the rotational speed of the wheel correlates with the amplitude of the imbalance, and otherwise not to detect an imbalance of the wheel.

The device can be designed to carry out further steps in the method. The device has advantages corresponding to those of the steps in the method.

The vehicle comprises the device and has advantages corresponding to those of the device.

### BRIEF DESCRIPTION OF THE DRAWINGS

Further advantageous embodiments will become apparent from the following description and the drawing. The drawings show:

FIG. 1 a vehicle with a device for detecting imbalance in a wheel of the vehicle,

FIG. 2 a method for detecting imbalance in the wheel of the vehicle.

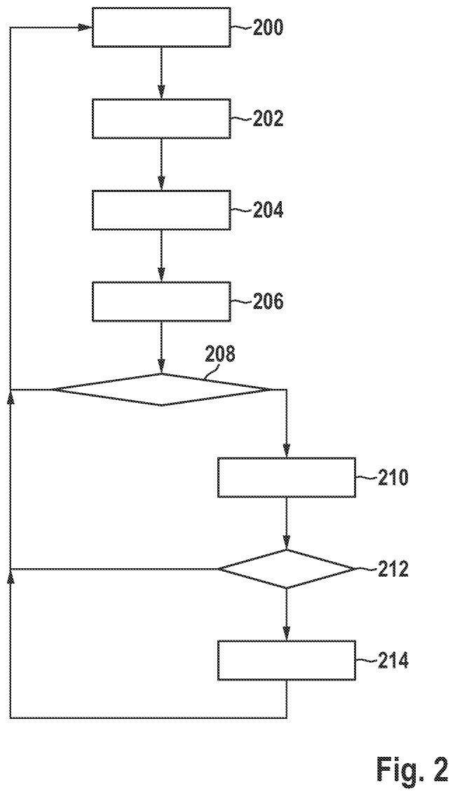

### DETAILED DESCRIPTION

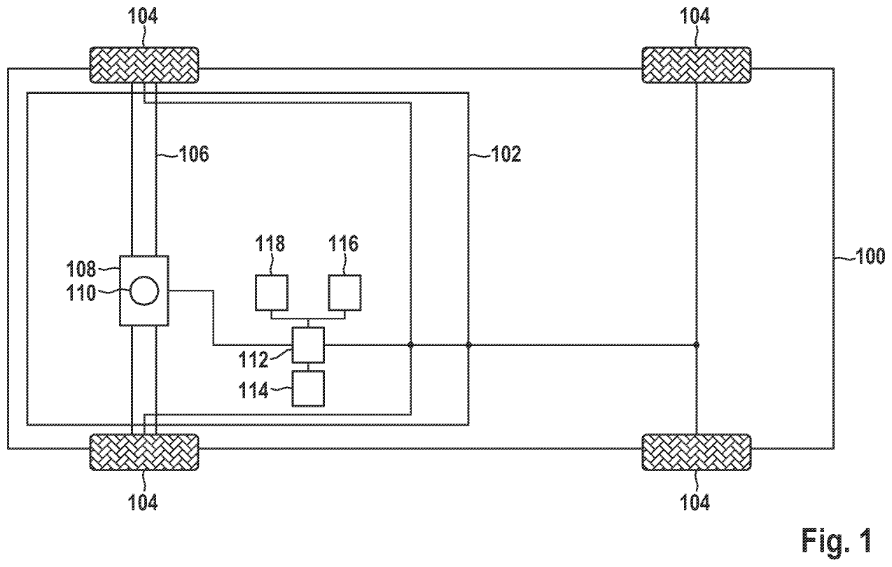

A vehicle 100 is shown schematically in FIG. 1.

The vehicle 100 comprises a device 102 for detecting imbalance of a wheel of the vehicle. In the example, the vehicle 100 comprises four wheels 104.

More or fewer than four wheels 104 may be provided.

The vehicle 100 comprises a steering system 106. The steering system 106 is designed to move one wheel 104 or a plurality of wheels 104 to steer the vehicle.

In the example, two wheels 104 that can be steered by the steering system 106 are provided.

The steering system 106 comprises a motor 108. The motor 108 has a rotor 110. The motor 108 is designed to steer one wheel 104 that can be steered or a plurality of wheels 104 that can be steered.

The device 102 is designed to identify a motor torque of the motor 108. The device 102 is designed to identify a rotor position of the rotor 110.

The device 102 is designed to detect an imbalance of the wheel 104 depending on the motor torque and the rotor position.

The device 102 is designed to identify an amplitude of a rotational speed of the respective wheels 104.

The device 102 is designed to determine an amplitude of the imbalance.

The device 102 is designed to detect the imbalance of the wheel 104 if the amplitude of the rotational speed of the wheel correlates with the amplitude of the imbalance.

The device 102 is designed otherwise not to detect any imbalance of the wheel 104.

The device 102 may be designed to carry out further steps in an imbalance detection method described below.

The device 102 comprises a computing device 112 designed to carry out the method.

The device 102 may comprise a display 114 designed to display a message to a driver.

The device 102 may comprise a memory 116 designed to store data.

The device 102 may comprise a transmitter 118 designed to transmit data, in particular to a receiver outside the vehicle 100.

In the method, conclusions are drawn about the condition, i.e., the presence of an imbalance in a wheel/tire combination or the presence of a correctly balanced wheel/tire combination, on the basis of the amplitude of the imbalances, i.e., on the basis of an amplitude of an imbalance characteristic which is calculated on the basis of the rotational speeds of the wheel in combination with the rotor position of the rotor 110 of the motor 108 of the steering system 106, in particular with high resolution.

The method can determine a frequency spectrum of a disturbance during an operation of the vehicle 100 based on an amplitude of the disturbance.

The method comprises a step 200.

In step 200, a motor torque of the motor 108 of the steering system 106 of the vehicle 100 is provided.

The method comprises a step 202.

In step 202, a rotor position of the rotor 110 is provided.

The method comprises a step 204.

In step 204, a rotational speed of the monitored wheels 104 is determined.

In the example, the rotational speed of a respective wheel 104 is filtered depending on a rotation frequency of the wheel.

The method comprises a step 206.

In step 206, an amplitude of a rotational speed of the respective wheels 104 and an amplitude of the imbalance are determined. In the example, the amplitude of the respective rotational speed of the wheel is determined as a function of the rotational speed of the respective wheel 104 filtered with the rotation frequency of the wheel.

In the example, the amplitude of the rotational speed of the wheel is determined for at least two wheels 104 of the vehicle.

The method comprises a step 208.

Step 208 checks whether there is an imbalance or not.

The imbalance is detected depending on the motor torque and the rotor position.

In the example, a spectrum of the motor torque is determined with a spectral analysis, in particular by means of Fast Fourier Transformation, or with an artificial intelligence trained for this purpose.

In the example, a spectrum of the rotor position is determined with a spectral analysis, in particular by means of Fast Fourier Transformation, or with an artificial intelligence trained for this purpose.

In the example, the imbalance is detected if the motor torque spectrum deviates from a target spectrum for the motor torque.

In the example, the imbalance is detected if the spectrum of the rotor position deviates from a target spectrum for the rotor position.

If the imbalance is detected, a step 210 is carried out. Otherwise, step 200 is carried out.

In step 210, in the example, the imbalance of one of the monitored wheels 104 is detected if the amplitude of the rotational speed of this wheel 104 correlates with the amplitude of the imbalance. Otherwise, no imbalance of this wheel 104 will be detected.

In the example, the imbalance of the monitored wheel 104 whose rotational speed amplitude correlates better with the amplitude of the imbalance is detected.

Subsequently, a step 212 is carried out.

In step 212, it is detected whether the amplitude of the imbalance of the wheel 104 exceeds a threshold or not. If the amplitude of the imbalance exceeds the threshold, a step 214 is carried out.

Otherwise, step 200 is carried out.

In step 214, an action is triggered in the example.

For example, a message is displayed to the driver of the vehicle indicating the imbalance.

It may be provided that the wheel 104 on which the imbalance is detected is determined. It is possible that the message displaying identifies the wheel on which the imbalance is detected.

For example, data is sent or stored that characterizes the amplitude of the imbalance or a progression of the amplitude of the imbalance. For example, data is sent that triggers a service appointment.

The data is stored in memory 116, for example. The data is sent with the transmitter 118, for example.

Subsequently, a step 200 is carried out.

It may be provided that the device 100 comprises several control units, in particular a first control unit for vehicle dynamics control and a second control unit for controlling the steering system 106. It may be provided that the device comprises a rotational speed sensor for each monitored wheel, which is designed to identify the rotational speed of the respective wheel 104. The device may be designed to use a rotor position signal from a single wheel drive for each monitored wheel.

For example, the first control unit is connected to the rotational speed sensors and is designed to provide the rotational speeds of the wheel.

The second control unit is designed, for example, to control the motor 108 and provide the motor torque and the rotor position.

What is claimed is:

1. A method for detecting imbalance of a wheel of a vehicle, comprising:
providing a motor torque of a motor of a steering system of the vehicle;
providing a position of a rotor of the motor; and
detecting the imbalance of a first wheel as a function of the motor torque and the rotor position.

2. The method according to claim 1, further comprising:
determining an amplitude of a rotational speed of the first wheel; and
determining an amplitude of the imbalance,
wherein
the imbalance of the first wheel is detected when the amplitude of the rotational speed of the first wheel correlates with the amplitude of the imbalance, and
no imbalance of the first wheel is detected when the amplitude of the rotational speed of the first wheel does not correlate with the amplitude of the imbalance.

3. The method according to claim 2, further comprising:
determining an amplitude of a rotational speed of a second wheel; and
detecting the imbalance of the first wheel comprises detecting that the amplitude of the rotational speed of the first wheel correlates better with the amplitude of the imbalance than the amplitude of the rotational speed of the second wheel correlates with the amplitude of the imbalance.

4. The method according to claim 2, wherein:
the rotational speed of the first wheel is filtered as a function of a rotation frequency of the first wheel; and
the amplitude of the rotational speed of the first wheel is determined as a function of the rotational speed of the first wheel filtered with the rotation frequency of the first wheel.

5. The method according to claim 1, wherein:
a spectrum of the motor torque and/or the rotor position is determined using a Fast Fourier Transformation, or using a trained artificial intelligence; and
the imbalance is detected when the spectrum deviates from a nominal spectrum.

6. The method according to claim 1, further comprising:
detecting that an amplitude of the imbalance of the first wheel exceeds a threshold; and
triggering a display of a message for a driver of the vehicle indicating the detected imbalance based upon the detected amplitude exceeding the threshold.

7. The method according to claim 6, wherein the displaying of the message identifies the first wheel as the wheel on which the imbalance is detected.

8. The method according to claim 1, further comprising:
detecting that an amplitude of the imbalance of the first wheel exceeds a threshold; and
sending or storing the amplitude of the imbalance or a progression of the amplitude of the imbalance in response to the detecting that the amplitude of the imbalance of the first wheel exceeds the threshold, or sending data triggering a service appointment in response to the detecting that the amplitude of the imbalance of the first wheel exceeds the threshold.

9. A device for detecting an imbalance of a wheel of a vehicle, the device designed to:
identify a motor torque of a motor of a steering system of the vehicle;
identify a rotor position of a rotor of the motor; and
detect an imbalance of a first wheel as a function of the motor torque and the rotor position.

10. The device according to claim 9, wherein the device is further designed to:
identify an amplitude of a rotational speed of the first wheel;
determine an amplitude of the imbalance; and
detect the imbalance of the first wheel when the amplitude of the rotational speed of the first wheel correlates with the amplitude of the imbalance; and
not detect an imbalance of the first wheel when the amplitude of the rotational speed of the first wheel does not correlate with the amplitude of the imbalance.

11. The device according to claim 9, wherein:
the device is designed to determine an amplitude of a rotational speed of a second wheel; and
detecting the imbalance of the first wheel comprises detecting that the amplitude of the rotational speed of the first wheel correlates better with the amplitude of the imbalance than the amplitude of the rotational speed of the second wheel correlates with the amplitude of the imbalance.

12. A vehicle comprising the device according to claim 9.
